(19) United States
(12) Patent Application Publication
(10) Pub. No.: US 2008/0125183 A1
(43) Pub. Date: May 29, 2008

(54) METHOD AND APPARATUS FOR LIGHTED PUSH-TO-CONNECT

(75) Inventors: JOHN M. BURGAN, NORTH PALM BEACH, FL (US); ALFREDO R. CARRERO, BOYNTON BEACH, FL (US); JOSE E. KORNELUK, LAKE WORTH, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/738,335

(22) Filed: Apr. 20, 2007

Related U.S. Application Data
(60) Provisional application No. 60/867,463, filed on Nov. 28, 2006.

(51) Int. Cl. H04M 1/57

(52) U.S. Cl. 455/567

(57) ABSTRACT

A method (10) and system (200) of lighted or colored push-to-connect can include awaiting (11) for a incoming push to connect signal (having caller identification information) such as a push to talk signal, retrieving (12) caller settings from a phonebook, look-up table or other source, and displaying (15) a push-to-connect color notification based on the caller identification information. The method can also include determining (13) if a color preference is stored for a particular caller and retrieving (14) a program display driver with parameters from a phonebook for if the color preference is stored and otherwise displaying (16) a push-to-connect color notification based on default attributes and caller identification information if no color preferences are stored.

### CROSS REFERENCE TO RELATED APPLICATIONS

This application claims the benefit of U.S. Provisional Patent Application No. 60/867,463, filed Nov. 28, 2006, the entire contents of which are incorporated by reference herein.

### FIELD

This invention relates generally to communication devices, and more particularly to a method and system for indicating caller information using light.

### BACKGROUND

A recent feature in Motorola's iDEN cellular phone devices includes a push-to-talk (PTT) lighted button. The lighted PTT button enables someone to easily find their phone if they are not wearing the phone when the PTT call comes in. From a distance you can see your phone and determine that it is receiving a PTT call. However, you can not tell who the call is from without picking up the phone and reading the caller identifier (Caller ID) information.

Another Motorola innovation included in Motorola's iDEN i733 Limited Edition phone provides the capability to display changing light patterns. However, currently these patterns, known as Northern Lights, are random and not tied to any caller identifier. Also, the existing PTT backlight feature, only displays an indication of an incoming PTT call or call alert and does not change colors based on caller identification information.

### SUMMARY

Embodiments in accordance with the present invention can provide a method and system enabling a wireless communication unit to provide additional user information without necessarily requiring a user to read a display. In several embodiments, a lighted presentation device can present different colors, color intensities or flash patterns based on the caller identification information associated with a push-to-connect call.

In a first embodiment of the present invention, a method of lighted push to connect can include the steps of awaiting an incoming push-to-connect signal, retrieving caller identification information associated with the push-to-connect signal, and displaying a color notification based on the caller identification information. The method can further retrieve caller settings from an electronic phonebook by retrieving color preferences for a given caller or retrieving a program display driver with parameters from the electronic phonebook. In other words, caller settings can include color preferences for the given caller or program display driver or parameters associated with a given caller that can be stored in a phonebook or other memory or storage location. The method can be used by a multimode wireless communication unit that receives the incoming push-to-connect signal where the method further includes the step of displaying a color notification based on the caller identification information and further based on specific system attributes detected from the incoming push-to-connect signal. The specific system attributes can include information extracted from an iDEN push-to-connect signal, a Voice over Internet Protocol push-to-connect signal, a push-to-connect over cellular signal, or an alternate push-to-connect signal. The method can also display a missed push-to-connect indication in the color notification based on the caller identification information when a wireless communication device receiving the push-to-connect signal is busy. The method can also assign a color to a given phonebook entry used for the color notification based on the caller identification information. The colors can also be selected among colors representative of pre-defined groups.

In a second embodiment of the present invention, a system of lighted push-to-connect on a wireless communication unit can include a presentation device and a processor coupled to the presentation device. The processor can be programmed to await an incoming push-to-connect signal, retrieve caller identification information associated with the push-to-connect signal, and display a color notification based on the caller identification information. The processor can be further programmed to retrieve caller settings from an electronic phonebook, for example, by retrieving color preferences for a given caller from the electronic phonebook or by retrieving a program display driver with parameters from the electronic phonebook. The system can further include a multimode wireless communication transceiver that receives the incoming push-to-connect signal and the processor can be further programmed to display a color notification based on the caller identification information and further based on specific system attributes detected from the incoming push-to-connect signal. As noted above, the specific system attributes can be for example information extracted from an iDEN push-to-connect signal, a Voice over Internet Protocol push-to-connect signal, a push-to-connect over cellular signal, or an alternate push-to-connect signal. The processor can be further programmed to display a different color intensity or flash pattern based on a priority assigned to the push-to-connect call. A color can be assigned to a given phonebook entry used for the color notification based on the caller identification information. The color can also be assigned to a given phonebook entry where the color is selected among colors representative of pre-defined groups.

In a third embodiment of the present invention, a portable wireless communication unit having a system of lighted push-to-connect can include a transceiver, a push-to-connect activation button for initiating or responding to a push-to-connect signal sent from or to the transceiver, a presentation device, and a processor coupled to the transceiver and the presentation device. The processor can be programmed to await an incoming or outgoing push-to-connect signal, retrieve caller identification information associated with the push-to-connect signal, and display a color notification based on the caller identification information on the presentation device. The presentation device can be a color display, a multicolor background light, a multicolored light emitting diode, or a multicolored light embedded within the push-to-connect button.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system. The “processor” as described herein can be any suitable component or combination of components, including any suitable hardware or software, that are capable of executing the processes described in relation to the inventive arrangements. A “push-to-connect” call as used herein is meant to generically include all types of rapid wireless connections including push-to-talk, push-to-view, push-to-listen, push-to-locate, or push-to-connect over cellular (PoC) on any number of wireless platforms or modes. Similarly, a push-to-connect activation button can include a button or other means (e.g., voice activation or other biometric activation) used to initiate the sending or receiving of a push-to-connect call or signal. “Caller Identification Information” can include information associated with a calling party that can include a phone number, a name identifier, or any other number or alphanumeric identifier available from a remote or local source. A “color notification” can be any color or even a sequence or random pattern of color illuminations that can be associated with caller identification information. The association can be between a color an individual or between a color and a group.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a flow chart of a method of lighted push to connect in accordance with an embodiment of the present invention.

FIG. 2 is an illustration of another method of lighted push to connect in accordance with an embodiment of the present invention.

FIG. 3 is a flow chart of an aspect of a method of lighted push to connect in accordance with an embodiment of the present invention.

FIGS. 4 and 5 are flow charts illustrating methods of entering a color assignment to a phonebook entry in accordance with embodiments of the present invention.

FIG. 6 is a block diagram of a system using lighted push-to-connect in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Embodiments herein can be implemented in a wide variety of exemplary ways that can enable a cell phone user to obtain additional information from their communication device without necessarily reading text on a display.

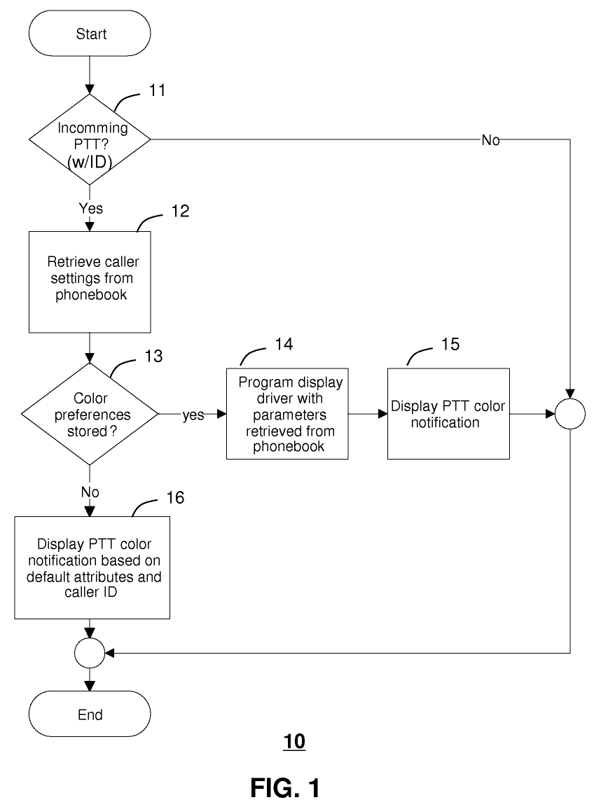

Referring to FIG. 1, a flow chart illustrating a method 10 of colored push-to-connect can include the steps of awaiting for a incoming push to connect signal (having caller identification information) such as a push to talk signal at decision step 11, retrieve caller settings from a phonebook, look-up table or other source at step 12, and display a push-to-connect color notification at step 15 based on the caller identification information. Note, the method can also include the step of determining if a color preference is stored for a particular caller at decision step 13 and retrieving a program display driver with parameters from a phonebook for example at step 14 if the color preference is stored and otherwise display a push-to-connect color notification based on default attributes and caller identification information at step 16 if no color preferences are stored at decision step 13.

In one embodiment, a device as contemplated herein can use a tri-color LED or an LED driver IC like the one used in Motorola's i733 handset to light the PTT button. A National Semiconductor IC LP3933 can alternatively provide 12-bit color (4-bits each R, G, and B) via pulse width modulation (PWM) RGB LED drivers with programmable color, brightness, turn on/off slopes and blinking patterns.

Humans can identify about 300 different colors from memory. The tri-color LED can be programmed to display a user selected color depending on the identifier of the caller initiating the push-to-connect call such as a PTT connection. The user can assign a color to each caller in their phone book or to a particular group of callers, and when a PTT call arrives from a particular caller or a particular caller belonging to a color associated group, the PTT button or other presentation device can light in the selected color. A call alert, which implies a higher priority than a regular PTT call, can be displayed as a brighter and/or faster flashing display of the same color based on settings and parameters set in the device.

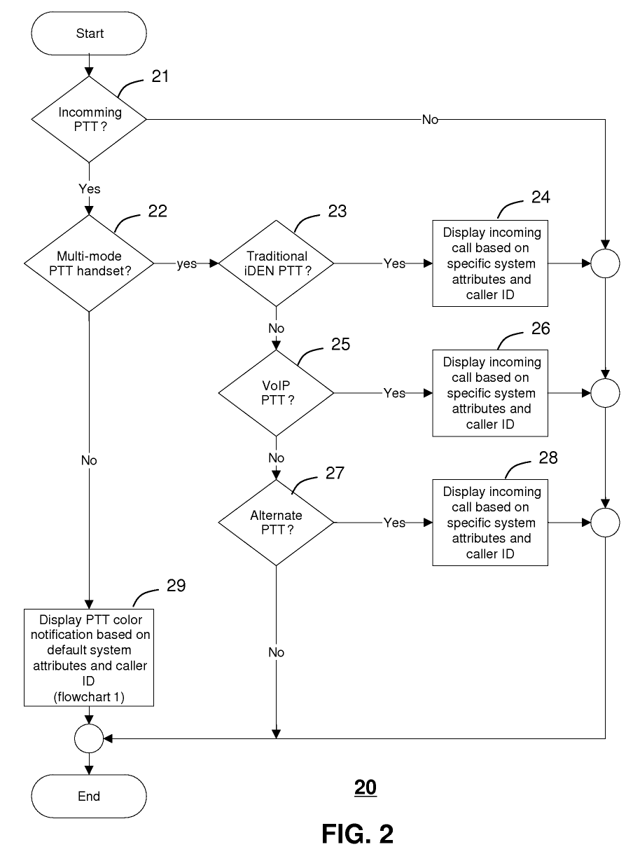

Another flow chart represented in FIG. 2 illustrating another method 20 of colored push-to-connect can provide ability to display different colors for different push-to-connect calls depending on which system such calls originated from. For example, dual-mode handsets such as a iDEN/CDMA handset and other handsets that might include multiple modes such as iDEN, CDMA, WLAN, WiMAX or other wireless technologies can make push-to-connect or PTT calls over the traditional iDEN system or establish a PTT call over VoIP or over other networks and protocols. Thus, the method 20 can wait for a push-to-connect call at decision step 21 and further determine if the receiving phone is a multimode phone capable of distinguishing system attributes at decision block 22. If the phone is not a multimode handset at decision step 22, then the method displays a push-to-connect color notification based on a default system attribute and caller identification information at step 29. If the call is from an iDEN network, then the color notification will be displayed based on the specific system attributes for iDEN and the caller identification information at step 24. If the call is not from an iDEN network, but rather from a VoIP network at decision step 25, then the color notification will be displayed based on the specific system attributes for the VoIP network and the caller identification information at step 26. If the call is not from an iDEN network or VoIP network, but rather from an alternate network at decision step 27, then the color notification will be displayed based on the specific system attributes for the alternate network and the caller identification information at step 28.

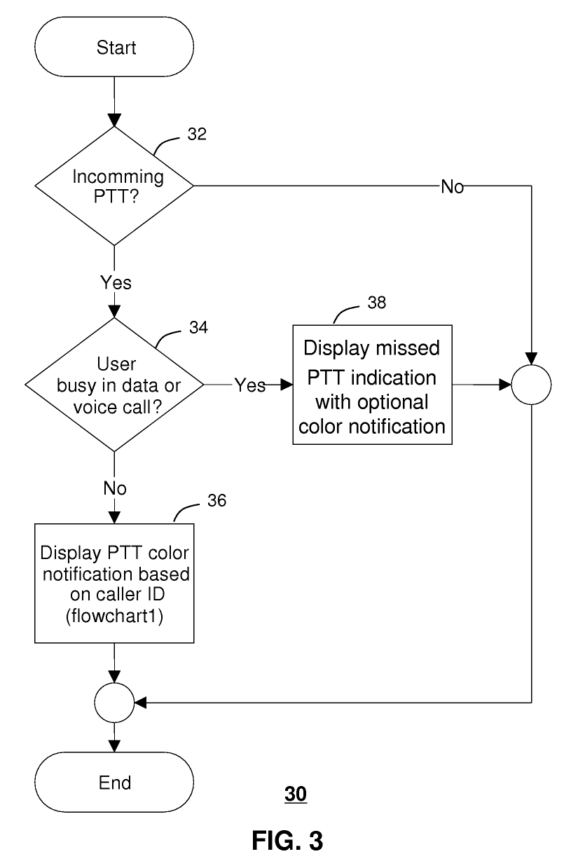

The multi-mode handset or other handset in accordance with the embodiments can have the ability to notify the user of an interconnect or cellular call when there is an incoming PTT call via an alert tone. This “Missed PTT” feature can be further enhanced by adding PTT backlight notification with color codes or other color lighting as contemplated herein. Referring to FIG. 3, a method 30 can await an incoming PTT call at decision step 32 and further determine if a phone user is busy on another voice or data call at decision step 34. If the user is busy, the handset can display a missed PTT indication which can optionally include a color notification associated with the caller at step 38. If the handset user is not busy with another call, the device at step 36 can display the appropriate color notification based on the caller identification information as similarly done in the flow charts 10 and 20 of FIGS. 2 and 3 respectively.

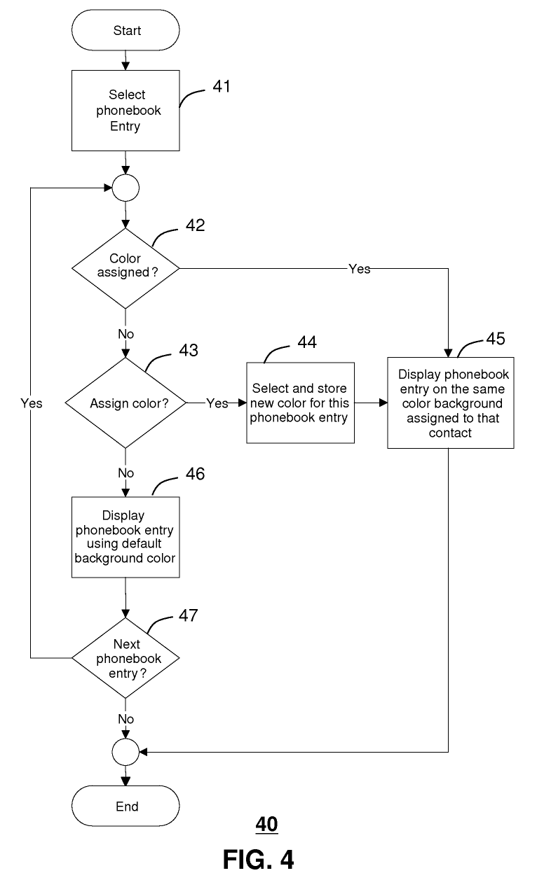

The flow chart of FIG. 4 illustrates a method 40 of assigning colors for phonebook entries. The method 40 can select a phonebook entry or create a new phonebook entry at step 41 and determine if a color is already assigned at decision step 42. If a color is already assigned or a default color is assigned for a new entry for example, then the phonebook entry can be displayed at step 45 with a background color (for example) with the assigned color assigned for the particular entry selected (or just created). If no color is assigned (or a default color is given), then the method 40 can prompt for a color assignment at decision step 43. If no color is to be assigned, the phonebook can display the entry using a default background color at step 46 and a next phonebook entry can be assigned a color at decision 47 if desired. If assignment of a color for an entry is desired at step 43, then the color is selected and stored for the particular phone book entry at step 44 and the phonebook entry can be displayed at step 45 using the newly assigned color.

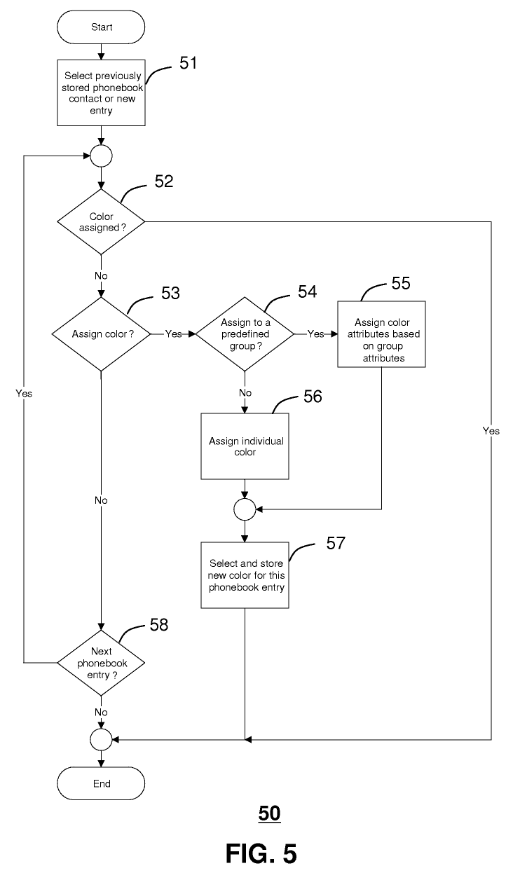

Similarly, a method 50 in FIG. 5 can assign colors for a phonebook entry based on a color associated with a predefined group. The predefined group can be a selective dynamic group that is created for group dispatch calls. At step 51, a previously stored phonebook contact or new entry can be selected. If a color is already assigned, then a user may end the method or alternatively assign a color at decision step 53. If a color assignment is indicated at step 53, then a determination of whether the entry is assigned or should be assigned to a predefined group is made at decision block 54. If the predefined group assignment is indicated at step 54, then a color is assigned that is associated with the predefined group and such entry is stored at step 57. If no predefined group is indicated at step 54, then the entry can be assigned an individual color at step 56 and subsequently stored at step 57. If no color assigned is desired for a particular entry, then a next phonebook entry can be assessed at decision block 58 for inclusion in a predefined group have a predefined color association.

Another embodiment in accordance with the invention can use predefined hues or flashing patterns based on groupings or categories. For example, a boss can be assigned a bright red color, whereas a coworker can be presented in a lighter shade of red, and a subordinate can be displayed in lighter pastel colors. This can be accomplished by mixing various degrees of white with the principal color to vary the color saturation. See FIG. 5 for how to assign a color based on groupings or categories.

Yet another embodiment can associate a priority with color and changes in brightness and/or saturation. Whereas a normal dispatch call can be displayed in a standard brightness (e.g., dark blue), dispatch call alerts can be associated with brighter values of the hue chosen for that user (e.g., a brighter blue). An emergency call can be displayed in an even brighter blue or a dedicated emergency color. These settings can be part of the display driver or part of the parameters retrieved from a phonebook for example.

Another possible extension to the embodiments herein can provide for the display of phonebook entries with the same background color as that assigned to each contact when a push-to-connect call is received from such contact. For example, if Mary is assigned red and Fred assigned orange, when the user scrolls through phonebook entries Mary's information can be displayed on a red background whereas Fred's information can be on an orange background. This can reinforce and assist a user in learning which colors are assigned to which contact more rapidly. Note, if a user does not wish to assign colors, colors can be assigned automatically and picked using an algorithm. Further note, the embodiments herein can use high efficiency LEDs that are controlled via pulse width modulated (PWM) signals that incur negligible current drain.

Although Caller ID has been used to trigger specific alert tones or even a specific wallpaper or background picture, caller ID has not been used in conjunction with a push-to-connect or PTT feature to trigger a color indication on the PTT button before indicative of a caller. Note, although several of the embodiments apply to any phone supporting a lighted push-to-connect button, it can equally apply to any device using other color presentation devices such as displays or LEDs that are not necessarily part of the PTT button.

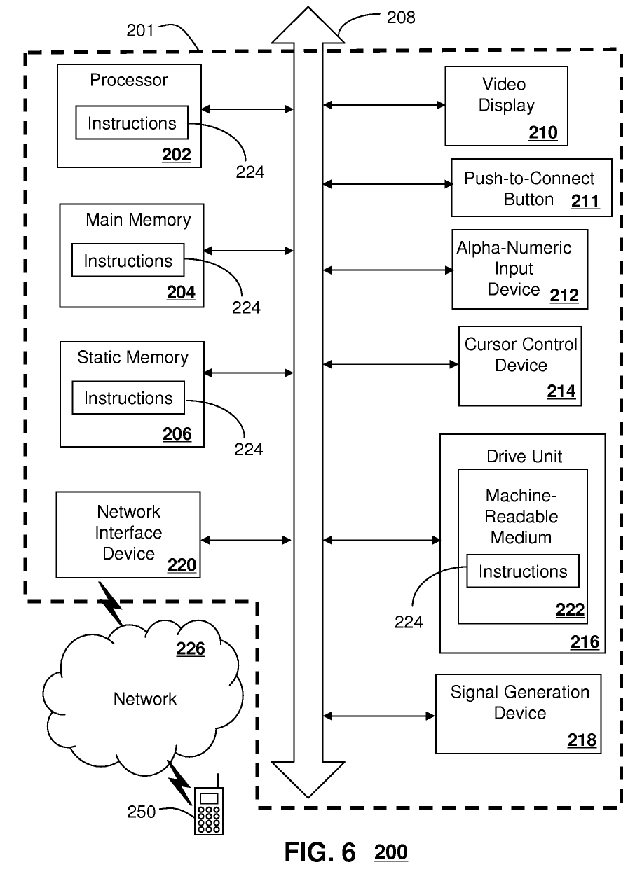

FIG. 6 depicts an exemplary diagrammatic representation of a machine in the form of a computer system 200 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. For example, the computer system can include a recipient device 201 and a sending device 250 or vice-versa.

The machine may comprise a server computer, a client user computer, a personal computer (PC), a tablet PC, personal digital assistant, a cellular phone, a laptop computer, a desktop computer, a control system, a network router, switch or bridge, or any machine capable of executing a set of instructions (sequential or otherwise) that specify actions to be taken by that machine, not to mention a mobile server. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 200 can include a controller or processor 202 (e.g., a central processing unit (CPU), a graphics processing unit (GPU, or both), a main memory 204 and a static memory 206, which communicate with each other via a bus 208. The computer system 200 may further include a presentation device such as a video display unit 210 (e.g., a liquid crystal display (LCD), a flat panel, a solid state display, or a cathode ray tube (CRT)). The computer system 200 may include a push-to-connect activation button 211, an input device 212 (e.g., a keyboard), a cursor control device 214 (e.g., a mouse), a disk drive unit 216, a signal generation device 218 (e.g., a speaker or remote control that can also serve as a presentation device) and a network interface device 220. Of course, in the embodiments disclosed, many of these items are optional.

The disk drive unit 216 may include a machine-readable medium 222 on which is stored one or more sets of instructions (e.g., software 224) embodying any one or more of the methodologies or functions described herein, including those methods illustrated above. The instructions 224 may also reside, completely or at least partially, within the main memory 204, the static memory 206, and/or within the processor 202 during execution thereof by the computer system 200. The main memory 204 and the processor 202 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but are not limited to, distributed processing or component/object distributed processing, parallel processing, or virtual machine processing can also be constructed to implement the methods described herein. Further note, implementations can also include neural network implementations, and ad hoc or mesh network implementations between communication devices.

The present disclosure contemplates a machine readable medium containing instructions 224, or that which receives and executes instructions 224 from a propagated signal so that a device connected to a network environment 226 can send or receive voice, video or data, and to communicate over the network 226 using the instructions 224. The instructions 224 may further be transmitted or received over a network 226 via the network interface device 220 which can include any device that receives or transmits signals such as a wired or wireless transceiver.

While the machine-readable medium 222 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of lighted push to connect, comprising the steps of:
awaiting an incoming push-to-connect signal;
retrieving caller identification information associated with the push-to-connect signal; and
displaying a color notification among a number of different color notifications based on the caller identification information.

2. The method of claim 1, wherein the method further comprises the step of retrieving caller settings from an electronic phonebook.

3. The method of claim 2, wherein the step of retrieving caller settings comprises the step of retrieving color preferences for a given caller.

4. The method of claim 2, wherein the step of retrieving caller settings comprises the step of retrieving a program display driver with parameters from the electronic phonebook.

5. The method of claim 1, wherein a multimode wireless communication unit receives the incoming push-to-connect signal and the method further comprises the step of displaying a color notification based on the caller identification information and further based on specific system attributes detected from the incoming push-to-connect signal.

6. The method of claim 5, wherein the specific system attributes comprises information extracted from an iDEN push-to-connect signal, a Voice over Internet Protocol push-to-connect signal, a push-to-connect over cellular signal, or an alternate push-to-connect signal.

7. The method of claim 1, wherein the method further comprises the step of displaying a missed push-to-connect indication in the color notification based on the caller identification information when a wireless communication device receiving the push-to-connect signal is busy.

8. The method of claim 1, wherein the method further comprises the step of assigning a color to a given phonebook entry used for the color notification based on the caller identification information.

9. The method of claim 1, wherein the method further comprises the step of assigning a color to a given phonebook entry selected among colors representative of pre-defined groups.

10. A system of lighted push-to-connect on a wireless communication unit, comprising:
a presentation device; and
a processor coupled to the presentation device, wherein the processor is programmed to:
await an incoming push-to-connect signal;
retrieve caller identification information associated with the push-to-connect signal; and
display a color notification based on the caller identification information.

11. The system of claim 10, wherein the processor is further programmed to retrieve caller settings from an electronic phonebook.

12. The system of claim 11, wherein the processor retrieves caller settings by retrieving color preferences for a given caller from the electronic phonebook.

13. The system of claim 11, wherein the processor retrieves caller settings by retrieving a program display driver with parameters from the electronic phonebook.

14. The system of claim 10, wherein the system further comprises a multimode wireless communication transceiver that receives the incoming push-to-connect signal and the processor is further programmed to display a color notification based on the caller identification information and further based on specific system attributes detected from the incoming push-to-connect signal.

15. The system of claim 14, wherein the specific system attributes comprises information extracted from an iDEN push-to-connect signal, a Voice over Internet Protocol push-to-connect signal, a push-to-connect over cellular signal, or an alternate push-to-connect signal.

16. The system of claim 10, wherein the processor is further programmed to display a different color intensity or flash pattern based on a priority assigned to the push-to-connect call.

17. The system of claim 10, wherein the processor is further programmed to assign a color to a given phonebook entry used for the color notification based on the caller identification information.

18. The system of claim 10, wherein the processor is further programmed to assign a color to a given phonebook entry selected among colors representative of pre-defined groups.

19. A portable wireless communication unit having a system of lighted push-to-connect, comprising:
a transceiver;
a push-to-connect activation button for initiating or responding to a push-to-connect signal sent from or to the transceiver;
a presentation device; and
a processor coupled to the transceiver and the presentation device, wherein the processor is programmed to:
await an incoming or outgoing push-to-connect signal;
retrieve caller identification information associated with the push-to-connect signal; and
display a color notification based on the caller identification information on the presentation device.

20. The portable wireless communication unit of claim 19, wherein the presentation device comprises a color display, a multicolor background light, a multicolored light emitting diode, or a multicolored light embedded within the push-to-connect button.
